(19) United States
(12) Patent Application Publication
(10) Pub. No.: US 2011/0217925 A1
(43) Pub. Date: Sep. 8, 2011

(54) Noise reducing near-field receiver antenna and system

(76) Inventors: Mark Rhodes, West Lothian (GB); Brendan Hyland, Edinburgh (GB)

(21) Appl. No.: 12/719,155

(22) Filed: Mar. 8, 2010

(51) Int. Cl. H04B 5/00; H04B 1/00

(52) U.S. Cl. 455/41.1; 455/63.1

(57) ABSTRACT

The present invention provides a noise reducing near-field antenna comprising a first and second antenna section and a digital signal processor. The first antenna section detects the magnetic field component of an incident signal and the second antenna section detects the electric field component of an incident signal. The first antenna section outputs a signal to the digital signal processor comprising a wanted magnetic field component of a near-field incident signal and a magnetic field component of an unwanted far-field noise signal. The second antenna section outputs the electric field component of the unwanted noise signal to the digital signal processor. The digital signal processor determines the magnetic field component of the unwanted incident signal from the electrical field component thereof and subtracts this value from the received signal of the first antenna section, thereby removing the unwanted noise signal from the near-field received signal.

### FIELD OF USE

The present invention relates to the field of noise reduction methods applied to antennas which are used for near-field wireless communications by means of magnetic signals. The present invention has a specific application in underwater environments.

### DESCRIPTION OF THE RELATED ART

Near field wireless communications by electromagnetic and/or magnetic signals have a range of applications. Examples of such applications include, docking stations for personal media devices, low-frequency environmental monitoring and control systems, and inductive communications systems. Other key application areas of near-field wireless communications by electromagnetic and/or magnetic signals are underwater communications, underwater control systems and through-the-earth communications and control systems.

Wireless communications using electromagnetic signals is a preferred means for underwater communications and data transfer. Similarly wireless communications using electromagnetic signals is a preferred means for through-the-earth communications and data transfer. Electromagnetic signals can be produced using well established radio circuitry and design. Electromagnetic signals can be divided into multiple channels, and data can be modulated onto each channel according to one of many modulation schemes. A vast range of protocols are available for the processing of data sent by electromagnetic signals.

Near-field electromagnetic signals can be characterized by a mathematical expression comprising three terms: a radiating term which is inversely proportional to the distance, R, from the source (i.e. varies as l/R); a quasi static term which varies inversely proportional to the square of the distance from the source (i.e. varies as l/R²); and a magnetic term which varies inversely proportional to the cube of the distance from the source (i.e. varies as l/R³). The quasi static term (l/R²) and the magnetic term (l/R³) dominate within a very short range of the transmitter—typically inside one wavelength of the transmitted signal. As the distance increases, the radiating term (l/R) dominates. The distance within which the quasi static term (l/R²) and the magnetic term (l/R³) dominate is defined as the near-field. Similarly, the quasi static term (l/R²) and the magnetic term (l/R³) are commonly referred to as near-field terms.

Far-field signals can be characterized substantially by a mathematical expression comprising a single term which varies inversely with distance (l/R). In the far field, the higher order terms (l/R²), (l/R³) are insignificant compared with the radiating (l/R) term.

Far-field signals can also be distinguished from near-field signals by the ratio of the magnetic field terms to the electric field terms. A mathematical solution describing a far-field signal can be derived from Maxwell's equations and the result produces a pair of wave equations: the first wave equation describes the behavior of the electric E-field; the second wave equation describes the behavior magnetic H-field. In the two wave equations, the E-field and the H-field are proportional to each other, and the constant of proportionality is defined as the characteristic impedance Z of the propagating medium.

Near-field electromagnetic signals can be predominantly magnetic signals, i.e. comprising only magnetic field terms or can be predominantly electric signals, i.e. comprising only electric field terms. Near-field signals which are produced by magnetically coupled antennas, such as loop antennas are predominantly magnetic signals. On the other hand, near-field signals which are produced by electrically coupled antennas are predominantly electric signals.

Underwater communications and through-the-earth communications by electromagnetic signaling are generally limited to a range within the near-field of the signal. Electromagnetic signals and radio waves are severely affected by the high conductivity of water—especially sea water. The high conductivity of water produces a very high level of attenuation with distance for an underwater radio signal. A similarly high level of attenuation with distance applies to a signal propagating underground.

Co-pending U.S. patent application Ser. No. 11/454,630—“Underwater Communications System and Method”, Rhodes et al, describes a method for underwater communications by electromagnetic signalling. This application is incorporated herein by reference. To overcome the effects of attenuation under water, the communications system taught in U.S. patent application Ser. No. 11/454,630 is typically implemented using low frequency carrier signals.

U.S. Pat. No. 7,043,204, “Through-the-Earth Radio”, Reagor teaches a system for wireless communications by means of low frequency electromagnetic signals. To overcome the effects of attenuation in the earth, Reagor also teaches a Radio system which uses low frequency carrier signals.

A defining specification of any wireless communications system is the maximum available data transfer rate. A higher maximum available data transfer rate is preferable over a lower maximum available data transfer rate. The limiting factors for data transfer rate are taught by C. E. Shannon in “Communication in the presence of noise”, Proc. Institute of Radio Engineers, vol. 37 (1): 10-21 (January 1949). In summary, the limiting factors are noise and bandwidth.

The upper limit of bandwidth for a signal is equal to the carrier frequency of the signal; hence, the use of low frequency carrier signals in the underwater wireless communications system of co-pending U.S. patent application Ser. No. 11/454,630 and the through-the-earth system of Reagor, limits the available bandwidth for these communications systems.

For systems where the available bandwidth is limited, it is possible to improve the data rate by reducing the noise.

Noise reduction techniques are taught in U.S. Pat. No. 6,968,171 “Adaptive Noise Reduction System for a Wireless Receiver”; R. Vanderhelm et al. The noise reduction system taught by Vanderhelm comprises a first antenna which receives a wanted signal superimposed with an unwanted noise signal and a second antenna which receives only the unwanted noise signal. Cancellation of the unwanted signal is implemented using a correlation method applied to the first and second signals. However, prior art correlation and noise cancellation methods, such as those taught by Vanderhelm, are not suited for use in low frequency applications, for example, in frequency limited underwater applications. Correlation is essentially a steady state process. Therefore, to correlate a pair of signals it is necessary to sample over several periods of a the pair of received signals before correlation can be established. For a low frequency system, a pre-defined cancellation algorithm for noise cancellation would be highly advantageous.

### SUMMARY OF THE INVENTION

Accordingly, an object of the present invention is to provide a noise reducing antenna suitable for near-field communications. The antenna of the present invention offers improved signal to noise ratio characteristics compared to prior-art near-field antennas.

According to a first aspect of the present invention a near-field receiver antenna is provided comprising a first antenna section, a second antenna section and a signal processor. The first antenna section receives a magnetic field component of an electromagnetic signal incident on the antenna and outputs a first received signal to the signal processor. The second antenna section receives an electric field component of an electromagnetic signal incident on the antenna and outputs a second received signal to the signal processor. A noise corrected signal is produced by the signal processor where the noise corrected signal is calculated by applying pre-defined mathematical operations to the first and second received signals.

Preferably, the first electromagnetic signal is a near-field signal and the second electromagnetic signal is a far-field signal.

Preferably, the pre-defined mathematical operations comprise adding a phase shift to the second received signal, multiplying the amplitude of the second received signal by a scaling factor and subtracting the phase shifted, amplitude scaled second signal from the first signal.

Preferably, at least one of the phase correction and the amplitude scaling factor applied to the second received signal is calculated from the characteristic impedance of the medium surrounding the antenna.

In one embodiment of the present invention, the antenna further comprises a meter to measure the electrical conductivity of the medium surrounding the antenna. The phase correction and the amplitude scaling factor applied to the second received signal may be calculated from the resulting measured electrical conductivity.

In some embodiments, the first antenna section of the near-field receiver antenna of the present invention comprises a magnetic loop antenna. In other embodiments the first antenna section is a solenoid antenna. Preferably, the loop or solenoid antenna is formed over a core having a high relative magnetic permeability.

In other embodiments the first antenna section is an antenna which receives a magnetic component of an electromagnetic signal. Examples of such antennas include, but are not limited to, flux gate magnetometers and SQIUD antennas.

In some embodiments, the second antenna section of the near-field receiver antenna of the present invention comprises a pair of electrodes. Optionally, the pair of electrodes of the second antenna section are arranged on opposite sides of the first antenna section.

In other embodiments, the second antenna section of the near-field receiver antenna of the present invention comprises a plurality pairs of electrodes arranged orthogonally. Preferably, the second received signal is calculated by an intermediate signal processor which receives signals from the plurality of electrode pairs, and adds the received signals vectorially.

According to a second aspect of the present invention a near-field receiver system is provided comprising a first antenna, a second antenna and a signal processor. The first antenna receives a magnetic field component of an incident electromagnetic signal and outputs a first received signal to the signal processor. The second antenna receives an electric field component of a second incident electromagnetic signal and outputs a second received signal to the signal processor. A noise corrected signal is produced by the signal processor where the noise corrected signal is calculated by applying pre-defined mathematical operations to the first and second received signals.

Embodiments of the present invention will now be described with reference to the accompanying figures in which:

### BRIEF DESCRIPTION OF DRAWINGS

FIG. 1 shows a noise reducing near-field receiver antenna according to a first embodiment of the present invention comprising a first antenna section for receiving a magnetic field component of an incident signal and a second antenna section for receiving an electric field component of an incident signal.

FIG. 2 shows a noise reducing near-field receiver antenna according to the present invention where a first wanted electromagnetic signal and a second noise electromagnetic signal are incident on the antenna.

FIG. 3 shows a noise reducing near-field receiver antenna according to a second embodiment of the present invention comprising second antenna section with elements for receiving orthogonal electrical field components of an incident signal.

FIG. 4 shows a block diagram of the signal processing circuitry of a near-field receiver antenna according to an embodiment of the present invention.

FIG. 5 shows a block diagram of signal processing circuitry capable of water conductivity measurements of a near-field receiver antenna according to an embodiment of the present invention.

### DETAILED DESCRIPTION

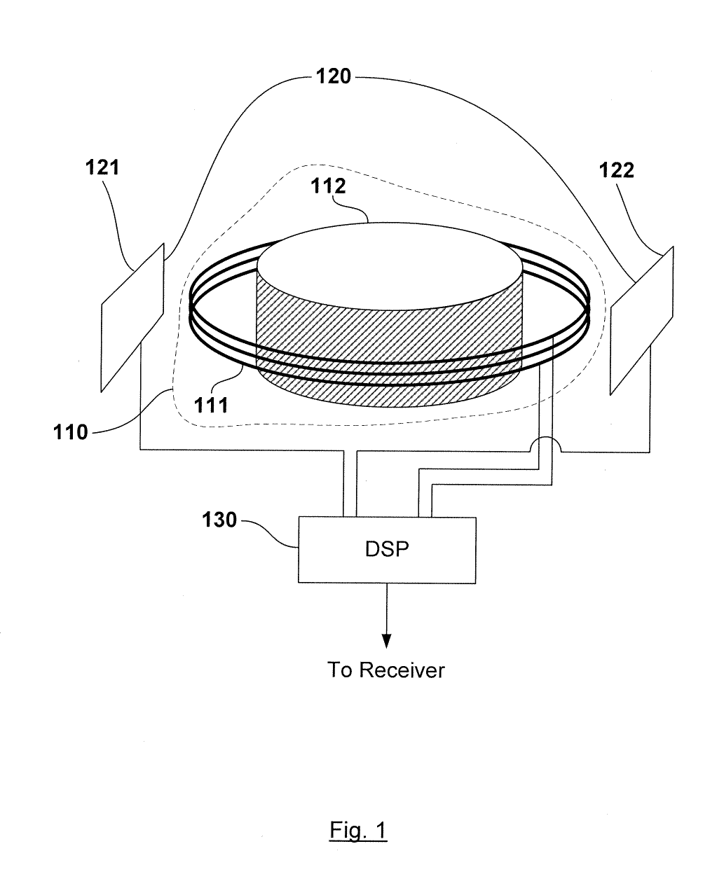

FIG. 1 shows a noise reducing near-field receiver antenna according to a first embodiment of the present invention. The antenna of FIG. 1 receives a first wanted signal which has an unwanted noise signal superimposed thereon and separately receives a second unwanted noise signal. A pre-determined correction is applied to the received noise signal, so that the noise signal can be cancelled from the first signal.

Near-field electromagnetic signals can be characterized by a mathematical expression comprising three terms: a radiating term which is inversely proportional to the distance, R, from the source (i.e. varies as l/R); a quasi static term which varies inversely proportional to the square of the distance from the source (i.e. varies as l/R²); and a magnetic term which varies inversely proportional to the cube of the distance from the source (i.e. varies as l/R³).

A near-field signal is defined herein as a signal which is within the region around it's associated transmitter where the quasi static term (l/R²) and/or the magnetic term (l/R³) of the signal are greater than or equal to the radiating term (l/R).

Physically, the near-field range of a signal is approximately the distance from the transmit antenna which is less than or equal to one wavelength A of the signal as shown in Equation 1a

Near-Field Signal, R≦λ Equation 1a

The near-field signal which is produced by a loop antenna or a coil antenna comprises only magnetic field components, and has electric field components which are zero or approximately equal to zero. Thus a near-field signal produced by a coil or loop is substantially a magnetic signal.

A far-field signal is defined herein as a signal which can be characterized substantially by a mathematical expression comprising a single term which varies inversely with distance, R, from its associated transmitter—i.e. varies as l/R.

Physically, the far-field range of a signal is approximately the distance from the transmit antenna which is greater than or equal to one wavelength λ of the signal as shown in Equation 1b

Far-Field Signal, R≧λ Equation 1b

In the far-field, a radio signal becomes a propagating wave. A propagating electromagnetic wave comprises electric field components and magnetic field components. The electric field components and the magnetic field components are perpendicular to the direction of propagation and are perpendicular to each other.

In a vacuum, the electric field components and the magnetic field components of a propagating wave are in phase. The ratio of the magnitude of the electric field component |E₀| to the magnitude of the magnetic field component |H₀| of a signal propagating in free-space a vacuum is give by equation 2.

|E₀|/|H₀|=Z₀ Equation 2

where Z₀ is the characteristic impedance of free space having a value of 376 Ω.

The ratio of the magnitude of the electric field component |E_{C}| to the magnitude of the magnetic field component |H_{c}| of a signal propagating in a conducting medium is given by equation 3.

|E_{C}|/|H_{C}|=Z₀\sqrt{ε₀μ₈ω/σ} Equation 3

where σ is the conductivity of the medium and ω is the angular frequency of the signal and μ_{R} is the relative permeability of the medium.

In a perfectly conducting medium, there is a phase difference of 45 degrees between the magnetic field components and the electric field components of a propagating wave. In a partially conducting medium, the phase difference between the magnetic field components and the electric field components falls somewhere between 0 and 45 degrees.

Thus, for any propagating wave in a medium, if either the electric field component or magnetic field component is known, and if the characteristic impedance of the medium is known, the other component can be calculated by applying a given phase correction and by applying an amplitude scaling factor.

For example, for a signal propagating in seawater, having an electrical conductivity of 4.8 S m⁻¹, the ratio of magnitudes of the magnetic and electric field components of a signal having a frequency of 1 kHz, is 0.04. In fresh water having an electrical conductivity of 0.005 S m⁻¹, this ratio increases to 1.25.

The antenna of FIG. 1 comprises magnetic loop antenna section 110, electric field antenna section 120, and digital signal processor 130. Magnetic loop antenna section 110 comprises a coil of wire 111 formed over a core 112 of a material having a high relative magnetic permeability. A value of 10 for the relative magnetic permeability is suitable to provide a substantial increase in the sensitivity of the antenna. Electric field antenna section 120 comprises a pair of field sensing electrodes 121, 122 which are arranged on opposite sides of magnetic loop antenna section 110.

During use, the noise reducing near-field receiver antenna of FIG. 1 receives a wanted first electromagnetic signal and an unwanted second electromagnetic signal. The wanted first electromagnetic signal is a near-field signal and comprises only magnetic field components, the unwanted second electromagnetic signal is a propagating electromagnetic signal and therefore comprises both electric and magnetic field components. The ratio of the electric and magnetic field components of the second signal is determined by the propagating medium surrounding the antenna. Magnetic loop antenna section 110 of FIG. 1, outputs a first electrical signal to the digital signal processor 130. The first electrical signal comprises the magnetic field component of the first electromagnetic signal with the magnetic field component of the second electromagnetic signal superimposed thereon. Electric field antenna section 120 outputs a second electrical signal to digital signal processor 130. The second electrical signal comprises the electric field component of the second electromagnetic signal. Digital signal processor 130 calculates the corresponding magnetic field component of the second electromagnetic signal. This is calculated by applying a pre-determined phase shift and amplitude scaling to the second electrical signal. The phase shifted and amplitude scaled second electrical signal is subtracted from the first electrical signal. Thus, the unwanted second electromagnetic signal is removed from the wanted first electromagnetic signal and a noise cancelled output from digital signal processor is provided.

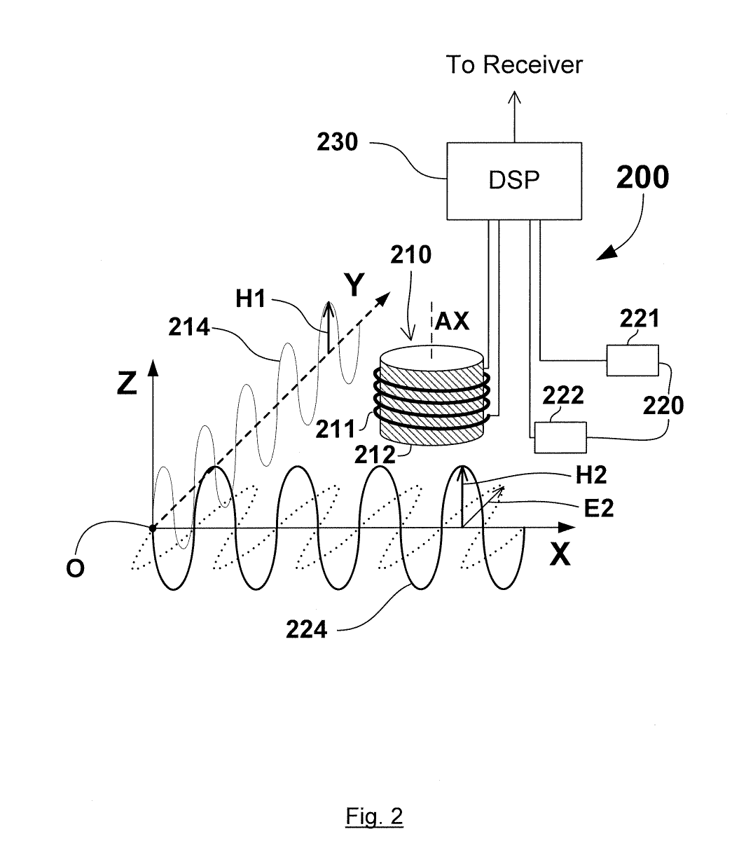

FIG. 2 shows a diagram of an antenna 200 according to the present invention comprising magnetic field sensing element 210, electric field sensing element 220 and digital signal processor 230. First electromagnetic signal 214 and second electromagnetic signal 224 are both incident on antenna 200. Magnetic field sensing element 210 of antenna 200 comprises a coil of wire 211 wound over a core 212 formed of a material with a high permeability; electric field sensing element 220 of antenna 200 comprises a pair of field sensing electrodes 221, 222. A three dimensional XYZ co-ordinate system is defined and is shown in FIG. 2. First electromagnetic signal 214 is the signal to be received, and this propagates in the positive Y direction. Second electromagnetic signal 224 is an unwanted noise signal and this propagates in the positive X direction. First electromagnetic signal 214 is a near-field signal and is produced by a magnetically coupled antenna. Thus, first electromagnetic signal 214 comprises only a magnetic field component. Alternatively, first electromagnetic signal has an electric field component which is negligible compared with its magnetic field component. Second electromagnetic signal 224 originates far away from antenna 200; hence second electromagnetic signal 224 is a far-field signal comprising electric field components and a magnetic field component.

It can be seen from FIG. 2 that first electromagnetic signal 214 has a magnetic field component H1 which is in the positive Z direction and which is parallel to the receiving axis AX of magnetic field element 210 of antenna 200. Second electromagnetic signal 224 has a magnetic field component H2 which is also in the positive Z direction and is also parallel to the receiving axis AX of magnetic field element 210 of antenna 200.

Due to the fact that first electromagnetic signal 214 has a vanishingly small electric field component, it is not detected by electric field sensing element 220. On the other hand, because second electromagnetic signal 224 is a propagating signal, it has a significant corresponding electrical field component E2. Electric field component E2 of second electromagnetic signal 224 is in the positive Y direction and is parallel to a line between electrodes 221, 222 of electric field sensing element 220 of antenna 200. The electric field component of second electromagnetic signal 224 is detected and is measured by electrodes 221, 222 of electric field sensing element 220. The corresponding magnetic field component of second electromagnetic signal 224 is calculated from the measured electric field component by applying amplitude and phase correction according to pre-defined properties of the propagating medium. The calculation of the magnetic field component of second signal 224 is carried out by digital signal processor 230.

Thus a correction can be applied to first electromagnetic signal 214 so as to cancel out the unwanted presence of second electromagnetic signal 224. This correction is applied by digital signal processor 230, which subtracts the calculated magnetic field component of second signal 224 from first signal 214.

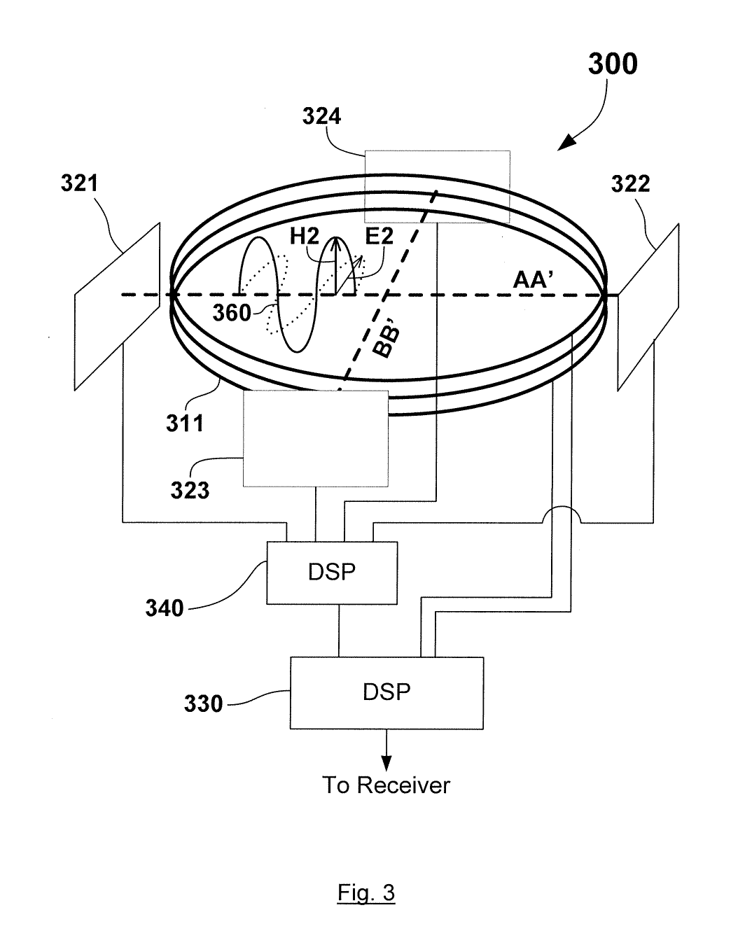

FIG. 3 shows a noise reducing near-field receiver antenna 300 according to a second embodiment of the present invention. The antenna of FIG. 3 comprises a magnetic loop antenna section which comprises coil 311, and an electric field antenna section which comprises electrodes 321, 322 and 323, 324 positioned around the circumference of coil 311. Line AA′ extends between electrodes 321, 322 and is perpendicular to line BB′ which extends between electrodes 323, 324. The noise reducing near-field receiver antenna of FIG. 3 further comprises signal processors 330 and 340. During use, a first electromagnetic signal (not shown) and a second electromagnetic signal 360 are incident on antenna 300. The first electromagnetic signal is a magnetic signal and is received only by the magnetic loop antenna section comprising coil 311. The direction of propagation of second electromagnetic signal 360 is in the plane of coil 311 and parallel to line AA′, so that the magnetic field component H2 of second electromagnetic signal 360 is also received by coil 311. For the specific case illustrated in FIG. 3, where the direction of propagation of second electromagnetic signal 360 is parallel to line AA′, electrodes 323 and 324 receive electric field component E2 of second electromagnetic signal 360.

Nonetheless, antenna 300 of FIG. 3 is capable of detecting an electric field component of any incident second signal having any direction in the plane defined by lines AA′ and BB′. The electrodes of the electric field antenna are arranged in pairs 321 paired with 322 and 323 paired with 324 so that each pair detects orthogonal electrical field components of electromagnetic signals. Thus, pair of electrodes 321, 322 detects an electric field component of a signal which is parallel to line AA′ and pair of electrodes 323, 324 detects an electric field component of a signal which is parallel to line BB′. Consequently, the electric field component of any second signal incident on antenna 300 of FIG. 3, where the direction of propagation of the signal is in the plane defined by line AA′ and line BB′ can be detected either wholly or partially by pair of electrodes 321, 322 and/or either wholly or partially by pair of electrodes 323, 324. A single electric field component of the incident second signal is then calculated by digital signal processor 340 from the electric field components detected by each pair of electrodes 321, 322 and 323, 324. For example, the electric field component may be calculated using the law of Pythagoras, i.e. by taking the square root of the sum of the squares of the signals detected by each pair of electrodes 321, 322 and 323, 324. In any case, the electric field component is calculated by adding the electric field components measured by each pair of electrodes 321, 322 and 323, 324 vectorially.

The corresponding magnetic field component of the incident second signal is calculated from the measured electric field component by applying amplitude and phase correction according to pre-defined properties of the propagating medium. The calculation of the magnetic field component of the second incident signal is carried out by digital signal processor 330.

The magnetic field component of the incident second signal is subtracted from the first signal so that a corrected noise reduced signal is output from digital signal processor 330 of antenna 300.

In a variation of the second embodiment of the near-field receiver antenna of the present invention shown in FIG. 3 electrodes 321, 322 and 323, 324 may be positioned so that they are adjacent to coil 311 as opposed to the configuration shown where they surround coil 311. In this case, coil 311 does not disturb the electric field arising from second electromagnetic signal 360 as it is incident on the region between electrodes 321 and 322 or on the region between 323 and 324.

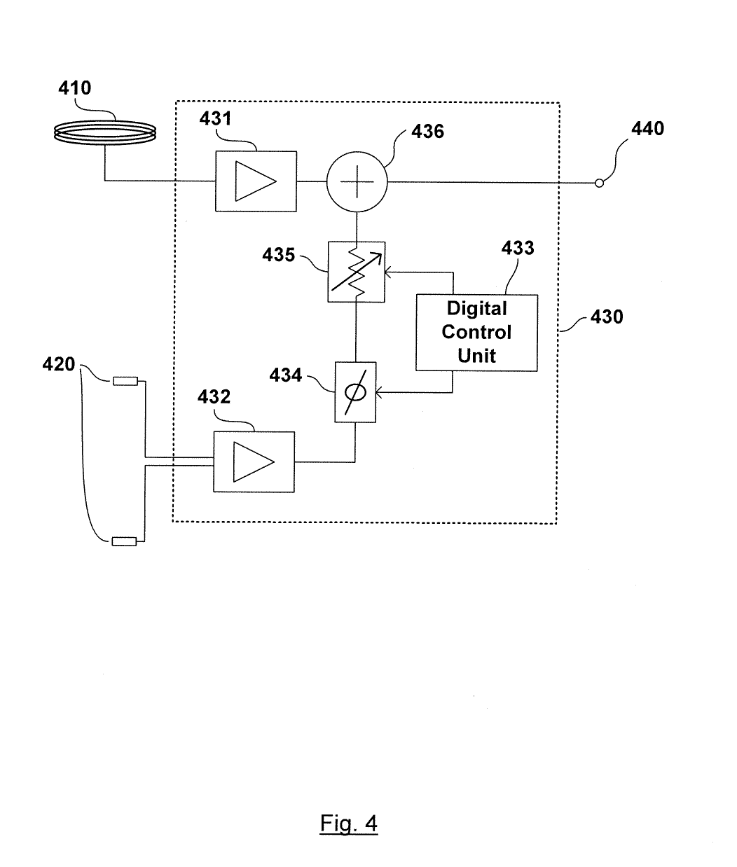

FIG. 4 shows a block diagram of a signal processing circuit 430 of a near-field receiver antenna according to an embodiment of the present invention. Signal processing circuitry 430 is operable to remove an unwanted far-field second signal from the wanted near-field signal which is received by the near-field receiver antenna of the present invention. Signal processing circuitry 430 comprises digital control unit 433 which applies a control signal to variable phase shifter 434 and amplitude scaling device 435. A first signal from magnetic loop antenna section 410 is amplified by low noise amplifier 431 of signal processing circuit 430 and is then fed to signal summing device 436. A second signal from electric field antenna section 420 is amplified by noise amplifier 432 of signal processing circuit 430. The amplified second signal is then fed to variable phase shifter 434 where a pre-defined phase shift is applied, and then to amplitude scaling device 435 where an amplitude scaling factor is applied. The phase shifted and amplitude scaled second signal is then passed to signal summing device 436 where it is summed with the amplified first signal. The summed first and second signals are then passed to an output 440 of signal processing circuit 430. Signal processing circuit 430 comprises programmable integrated circuits and other electronic devices (not shown) as required and as would be known to a person skilled in the art of electronic circuit design and system design.

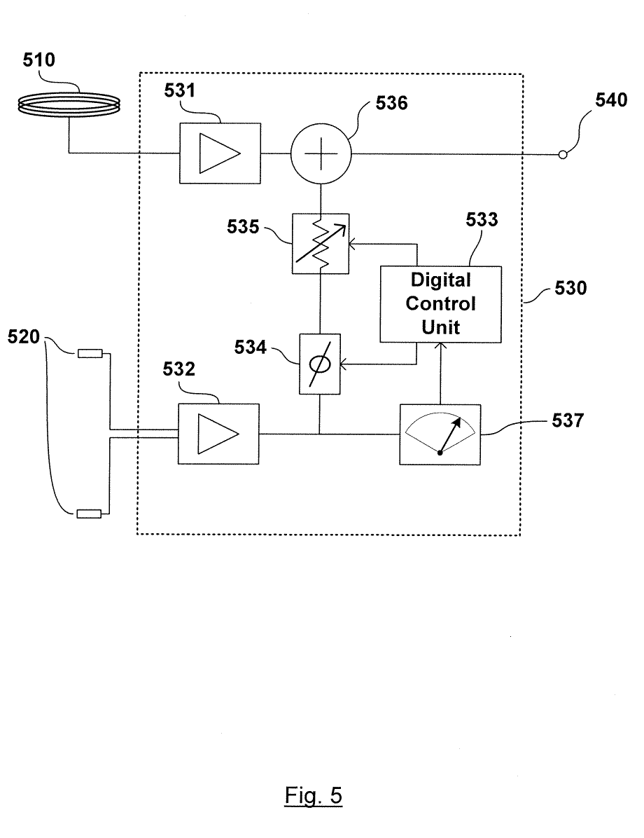

FIG. 5 shows a block diagram of a signal processing circuit 530 with integrated water conductivity measurement capability of a near-field receiver antenna according to an embodiment of the present invention. Signal processing circuitry 530 is operable to remove an unwanted far-field second signal from the wanted near-field signal which is received by the near-field receiver antenna of the present invention. Signal processing circuitry 530 is further operable to determine the electrical conductivity of water so that phase correction and amplitude scaling factors can be pre-determined. Signal processing circuitry 530 comprises digital control unit 533 which applies a control signal to variable phase shifter 534 and amplitude scaling device 535. A first signal from magnetic loop antenna section 510 is amplified by low noise amplifier 531 of signal processing circuit 530 and is then fed to signal summing device 536. A second signal from electric field antenna section 520 is amplified by noise amplifier 532 of signal processing circuit 530. A portion of the amplified second signal is then fed to electrical conductivity meter 537, and a portion of the amplified second signal is fed to signal summing device 536 via variable phase shifter 534 and amplitude scaling device 535. An output from electrical conductivity meter 537 is fed to digital control unit 533. Appropriate phase shifts and amplitude scaling factors are determined by digital control unit 533, and outputs from digital control unit 533 are applied to variable phase shifter 534 and amplitude scaling device 535 so that the correct phase shift and amplitude scaling is applied to the amplified second signal by variable phase shifter 534 and amplitude scaling device 535 respectively. The phase shifted and amplitude scaled second signal is summed with the amplified first signal. The summed first and second signals are then passed to an output 540 of signal processing circuit 530.

Since the impedance of the propagating medium is generally well known, it is possible to apply known pre-defined phase corrections and amplitude scaling factors to the second signal. For example, equation 3 gives the ratio of the magnitude of the magnetic field to the electric field for a given propagating medium. The value determined by equation 3 combined with measured values of the gain of magnetic field antenna section 410 and electric field antenna section 420 can be used to compute the scaling factor of amplitude scaling device 435 which is applied to the second signal. Similarly, for a given medium the phase between the electric and magnetic field components of a signal are known. The scaling factor and the phase correction factor are applied to the second signal without the need for feedback loops and without the need for a correlation means as employed by prior art noise reducing systems.

The various embodiments of the noise reducing near-field receiver antenna the present invention are described herein with particular emphasis on a first antenna section comprising a magnetic loop antenna which can receive a magnetic field component of a near-field first signal. Several alternative antennas would be suitable for use in the present invention, such alternatives include but are not limited to, flux gate magnetometers, SQIUD antennas.

Similarly, the various embodiments of the noise reducing near-field receiver antenna the present invention are described herein with particular emphasis on a second antenna section comprising a pair of field sensing electrodes. Several alternative antennas would be suitable for use in the present invention, such alternatives include, but are not limited to, rod antennas T-shaped antennas, dipole antennas, ball antennas, beam antennas.

Embodiments of the noise reducing near-field receiver antenna of the present invention are described herein with particular emphasis on underwater environments. However, the present invention is equally applicable to any environment where an unwanted far-field noise signal is to be subtracted from a wanted near field electromagnetic signal. Any optimization of the present invention to suit particular operating environments or for specific water constitutions remains within the scope of the present invention.

The descriptions of the specific embodiments herein are made by way of example only and not for the purposes of limitation. It will be obvious to a person skilled in the art that in order to achieve some or most of the advantages of the present invention, practical implementations may not necessarily be exactly as exemplified and can include variations within the scope of the present invention.

What is claimed is:

1. A near-field receiver antenna comprising
a first antenna section, which in operation, receives a magnetic field component of a first electromagnetic signal incident on said antenna and outputs a first electrical signal to a signal processor;
a second antenna section, which in operation, receives at least one electrical field component of a second electromagnetic signal incident on said antenna and outputs a second electrical signal to said signal processor;
wherein, during operation, said signal processor calculates and produces a noise corrected signal from pre-defined mathematical operations on said first and said second electrical signals.

2. A near-field receiver antenna according to claim 1 wherein said first electromagnetic signal is a near-field signal and wherein said second electromagnetic signal is a far-field signal.

3. A near-field receiver antenna according to claim 1 wherein said pre-defined mathematical operations comprise adding a phase shift to said second electrical signal, multiplying said second electrical signal by a scaling factor and subtracting said phase adjusted and amplitude scaled second electrical signal from said first electrical signal.

4. A near-field receiver antenna according to claim 3 wherein at least one of said phase shift and said amplitude scaling factor is determined from the characteristic impedance of the medium around said antenna.

5. A near-field receiver antenna according to claim 1 further comprising an electrical conductivity measuring device to measure the electrical conductivity of the medium around said antenna.

6. A near-field receiver antenna according to claim 5 wherein at least one of said phase shift and said amplitude scaling factor is determined from the measured electrical conductivity of the medium around said antenna.

7. A near-field receiver antenna according to claim 1 wherein said first antenna section comprises a loop antenna.

8. A near-field receiver antenna according to claim 1 wherein said first antenna section comprises a solenoid antenna.

9. A near-field receiver antenna according to claim 1 wherein said first antenna section is formed around a core having a high relative magnetic permeability.

10. A near-field receiver antenna according to claim 1 wherein said first antenna section comprises an antenna which detects a magnetic field component of an electromagnetic signal.

11. A near-field receiver antenna according to claim 1 wherein said second antenna section comprises an antenna which detects an electrical field component of an electromagnetic signal.

12. A near-field receiver antenna according to claim 1 wherein said second antenna section comprises a pair of electrodes.

13. A near-field receiver antenna according to claim 12 wherein said electrodes are arranged on either side of said first antenna section.

14. A near-field receiver antenna according to claim 1 wherein said second antenna section comprises a plurality of elements arranged to detect orthogonal electrical field component of said second electromagnetic signal.

15. A near-field receiver antenna according to claim 14 wherein said detected orthogonal electrical field components of said second electromagnetic signal are fed to said signal processor via an intermediate signal processor.

16. A near-field receiver antenna according to claim 15 wherein said second electrical signal is calculated by said intermediate signal processor.

17. A near-field receiver antenna according to claim 14 wherein said detected orthogonal electrical field components of said second electromagnetic signal are added vectorially to produce said second received signal.

18. A near-field receiver system comprising
a first antenna, which in operation, receives a magnetic field component of a first incident electromagnetic signal and outputs a first received signal to a signal processor;
a second antenna, which in operation, receives at least one electrical field component of a second incident electromagnetic signal and outputs a second received signal to said signal processor;
wherein, during operation, said signal processor calculates and produces a noise corrected signal from pre-defined mathematical operations on said first and said second received signals.
